(19) United States
(12) Patent Application Publication
(10) Pub. No.: US 2017/0271751 A1
(43) Pub. Date: Sep. 21, 2017

(54) COGNITIVE RADIO ANTENNA ASSEMBLY

(71) Applicant: KING FAHD UNIVERSITY OF PETROLEUM AND MINERALS, Dhahran (SA)

(72) Inventors: MOHAMMAD S. SHARAWI, DHAHRAN (SA); RIFAQAT HUSSAIN, DHAHRAN (SA)

(21) Appl. No.: 15/614,511

(22) Filed: Jun. 5, 2017

Related U.S. Application Data
(63) Continuation-in-part of application No. 14/641,253, filed on Mar. 6, 2015.

(51) Int. Cl. H01Q 1/24; H01Q 9/42; H01Q 21/28; H01Q 1/38; H01Q 5/321

(52) U.S. Cl. CPC H01Q 1/243; H01Q 1/38; H01Q 5/321; H01Q 21/28; H01Q 9/42

(57) ABSTRACT

The cognitive radio antenna assembly includes two boards, a main board that has an ultra-wideband antenna (UWB) and also serves as a ground plane for the reconfigurable antenna, and an elevated MIMO board having two planar inverted-F antennas (PIFAs) that are reconfigurable to selectively operate on different frequency bands. Each PIFA has a radiating patch having a slot bridged by PIN diodes and DC blocking capacitors on opposite sides of the slot. The resonant frequency of each PIFA is controlled by which diodes are switched on and off. The PIFA antennas are shorted to the ground plane the (UWB antenna) on the main board by shorting walls. The PIFA antennas are capable of resonating from the 700 MHz band through 3000 MHz, while the UWB senses the spectrum over the entire bandwidth. The antenna assembly is compact, being suitable for cellular phone and wireless applications in 4G wireless standards.

### CROSS-REFERENCE TO RELATED APPLICATION

This application is a continuation-in-part of U.S. patent application Ser. No. 14/641,253, filed on Mar. 6, 2015.

### BACKGROUND OF THE INVENTION

1. Field of the Invention

The present invention relates to communication systems, and particularly to a cognitive radio antenna assembly that includes an ultra-wide band sensing antenna and reconfigurable multiple-input-multiple-output (MIMO) antennas and is operable in multiple bands between 700 MHz and 3 GHz.

2. Description of the Related Art

In modern wireless communications, the exponential growth of wireless services results in an increasing demand of the data rate requirements and reliability of data. These services can include high quality audio/video calls, online video streaming, video conferencing and online gaming, for example. These services can require wide bandwidth operation or covering operation across several frequency bands. This resulted in efforts to make efficient utilization of the available spectrum via sensing the available unused or underutilized bands.

Overcoming the inefficient and highly underutilized spectrum resources has led to the concept of cognitive radio (CR). CR systems are based on the structural design of software-defined radio (SDR) intended to enhance the spectrum utilization efficiency by interacting with the operating environment. A CR-based system should be aware of its environment by sensing the spectrum usage, and should also have the capability to switch over the operating points among different unoccupied frequency bands. CR-based systems may cover various features, including sensing spectrum of nearby devices switching between different frequency bands, and power level adjustment of transmitting antennas.

The front end of a CR can include two antennas, one being an ultra-wide band (UWB) sensing antenna and the other being a reconfigurable communication antenna. The UWB antenna can be used to sense the entire spectrum of interest, while the reconfigurable antenna can be used to dynamically change the basic radiating characteristic of the antenna system to utilize the available bandwidth.

Reconfigurable antennas are able to change their operating fundamental characteristics, i.e., resonance frequency, radiation pattern, polarization, and impedance bandwidth. A frequency reconfigurable antenna is a component of CR platforms. A feature of such an antenna is its switching across several frequency bands by activating different radiating parts of the same antenna. CR-based systems are capable of switching the frequency bands of single frequency reconfigurable antennas over different bands to efficiently and inclusively utilize the idle spectrum.

The high date rate requirement due to continuous escalation in wireless handheld device services can be accomplished by employing reconfigurable MIMO antenna systems. MIMO antenna systems are adopted to increase the wireless channel capacity and reliability of data requirements. A key feature of a MIMO antenna system is its ability to multiply data throughput with enhanced data reliability using the available bandwidth, which results in improved spectral efficiency.

To achieve the desired characteristics of reconfigurability and desired performance of MIMO antenna systems, several challenges need to be overcome to accomplish these tasks. These issues include the size of the antennas for low frequency bands, high isolation that is needed between closely spaced antennas, and control circuitry that is needed to be embedded within the given antenna size to achieve the desired reconfiguration. Moreover, the performance of the MIMO system degrades significantly for closely spaced antennas due to high mutual coupling. Additionally, a CR system requires an UWB sensing antenna to scan the wide frequency band. The design of the sensing antenna with the strict dimensions of a mobile terminal size can be a challenging job, as the sensing antenna is required to cover lower frequency bands as well.

Thus, a cognitive radio antenna assembly solving the aforementioned problems is desired.

### SUMMARY OF THE INVENTION

The cognitive radio antenna assembly includes both a main board and an elevated MIMO board. The main board has an ultra-wideband antenna (UWB) disposed thereon, which serves an additional function as a ground plane for the reconfigurable antenna. The elevated MIMO board has two planar inverted-F antennas (PIFAs) disposed thereon that are reconfigurable to selectively operate on different frequency bands. Each PIFA has a radiating patch having a slot bridged by PIN diodes and DC blocking capacitors on opposite sides of the slot. The resonant frequency of each PIFA is controlled by which diodes are switched on and off. The PIFA antennas are shorted to the ground plane (the UWB antenna) on the main board by shorting walls. The PIFA antennas are capable of resonating from the 700 MHz band through 3000 MHz, while the UWB senses the spectrum over the entire bandwidth. The antenna assembly is compact, being suitable for cellular phone and wireless applications in 4G networks.

These and other features of the present invention will become readily apparent upon further review of the following specification and drawings.

### BRIEF DESCRIPTION OF THE DRAWINGS

FIG. 1 is a perspective view of cognitive radio antenna assembly according to the present invention.

FIG. 2 is a bottom view of the main board of the cognitive radio antenna assembly of FIG. 1.

FIG. 3 is a top view of the upper or MIMO board of the cognitive radio antenna assembly of FIG. 1.

FIG. 4 is a bottom view of the upper or MIMO board of the cognitive radio antenna assembly of FIG. 1.

FIG. 5A is a side view of the cognitive radio antenna assembly of FIG. 1.

FIG. 5B is a front view of the cognitive radio antenna assembly of FIG. 1.

FIG. 6 is a plot showing the reflection coefficient curves of the cognitive radio antenna assembly of FIG. 1 operating in Mode 1.

FIG. 7 is a plot showing the reflection coefficient curves of the cognitive radio antenna assembly of FIG. 1 operating in Mode 2.

FIG. 8 is a plot showing the reflection coefficient curves of the cognitive radio antenna assembly of FIG. 1 operating in Mode 3.

FIG. 9 is a plot showing the reflection coefficient curves of the cognitive radio antenna assembly of FIG. 1 operating in Mode 4.

FIG. 10 is a plot showing the simulated mutual coupling curves of the reconfigurable MIMO antennas of the cognitive radio antenna assembly of FIG. 1.

FIG. 11 is a plot showing the measured mutual coupling curves of the reconfigurable MIMO antennas of the cognitive radio antenna assembly of FIG. 1.

Similar reference characters denote corresponding features consistently throughout the attached drawings.

### DETAILED DESCRIPTION OF THE PREFERRED EMBODIMENTS

The cognitive radio antenna assembly includes two boards, a main board that has an ultra-wideband antenna (UWB) and also serves as a ground plane for the reconfigurable antenna, and an elevated MIMO board having two planar inverted-F antennas (PIFAs) that are reconfigurable to selectively operate on different frequency bands. Each PIFA has a radiating patch having a slot bridged by PIN diodes and DC blocking capacitors on opposite sides of the slot. The resonant frequency of each PIFA is controlled by which diodes are switched on and off. The PIFA antennas are shorted to the ground plane (the UWB antenna) on the main board by shorting walls. The PIFA antennas are capable of resonating from the 700 MHz band through 3000 MHz, while the UWB senses the spectrum over the entire bandwidth. The antenna assembly is compact, being suitable for cellular phone and wireless applications in 4G networks.

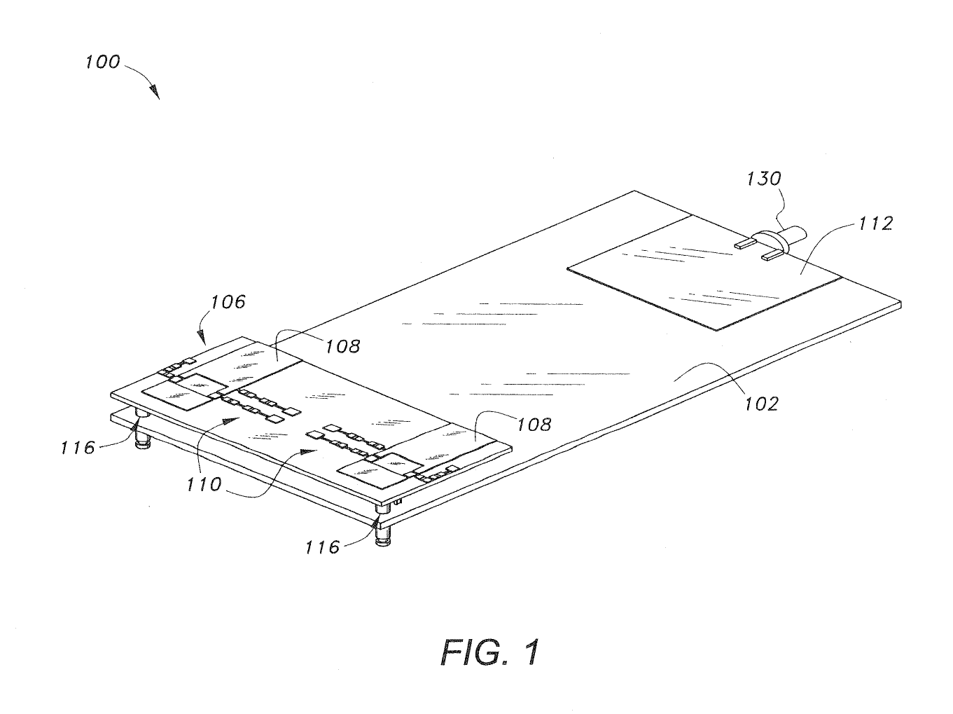

Referring to FIGS. 1-5B, the cognitive radio antenna assembly 100 has a main board 102 and an upper or elevated MIMO board 106 raised above the main board 102 by spacers or standoffs. Each board 102, 106 is made from a flat sheet or panel of dielectric material that is clad with copper on both sides. The copper is etched or removed from the opposing faces of the boards 102, 106 to form the patterns shown in the drawings. The boards 102, 106 may be made from printed circuit boards. For example, the main board 102 may be made from printed circuit board having a dielectric constant ∈ᵣ=4.4 and a thickness of 1.56 mm, and the upper or MIMO board 106 may be made from an FR-4 printed circuit board having a dielectric constant ∈ᵣ=4.4 and a thickness of 0.8 mm. The height of the two-board assembly is about 5.8 mm.

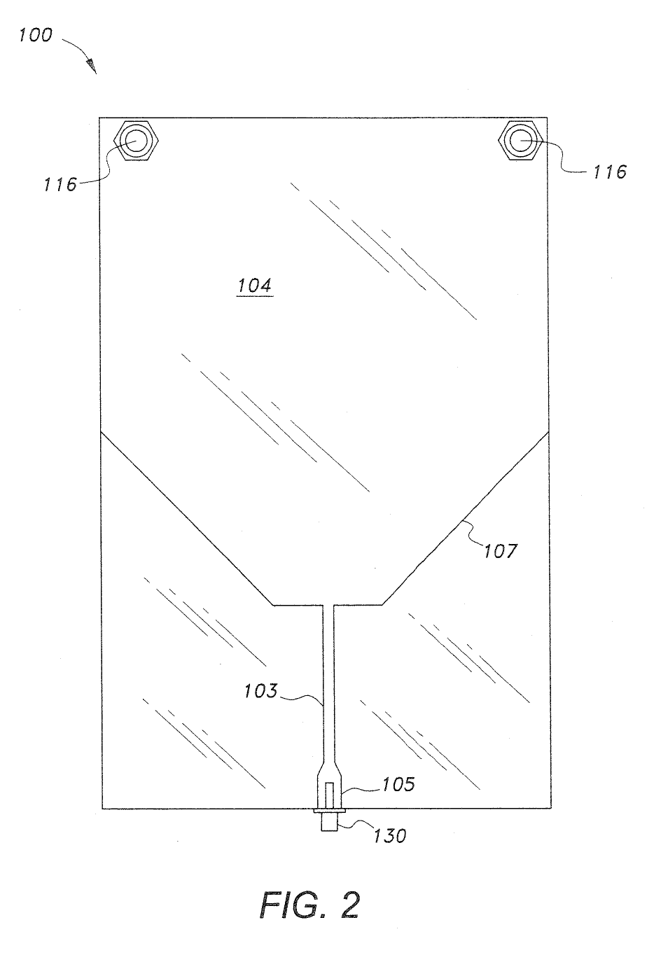

The main board 102 may have dimensions of 65 mm×120 mm. The ultra-wideband antenna is a monopole antenna formed on the main board 102. The sensing element 104 of the ultra-wideband antenna is formed on the bottom face of the main board 102, as shown in FIG. 2. The sensing element 104 has a rectangular base measuring about 65 mm×54.72 mm and a trapezoidal portion extending from the base. The trapezoidal portion has a base leg of 65 mm, a parallel upper leg of 16 mm, and opposing diagonal legs of 39 mm. A 1.5 mm wide transmission line 103 extends from the upper leg of the trapezoidal portion to the edge of the main board 102 (a length of about 34.8 mm), terminating in a 3 mm wide terminal pad 105. The center line of the transmission line 103 bisects the width of the main board 102 (about 32.5 mm from the longitudinal edge of the main board 102. Two SMA connectors 116 are mounted on the upper two corners of the UWB sensing antenna 104. As shown in FIG. 1, a rectangular ground plane 112 measuring 25 mm×40 mm is formed on the top face of the main board 102. The ultra-wideband antenna is capable of sensing or receiving the entire spectrum from about 700 MHz to about 3 GHz. The sensing element 104 of the ultra-wideband antenna also serves as a ground plane or ground reference for the reconfigurable MIMO antenna on the upper or MIMO board 106.

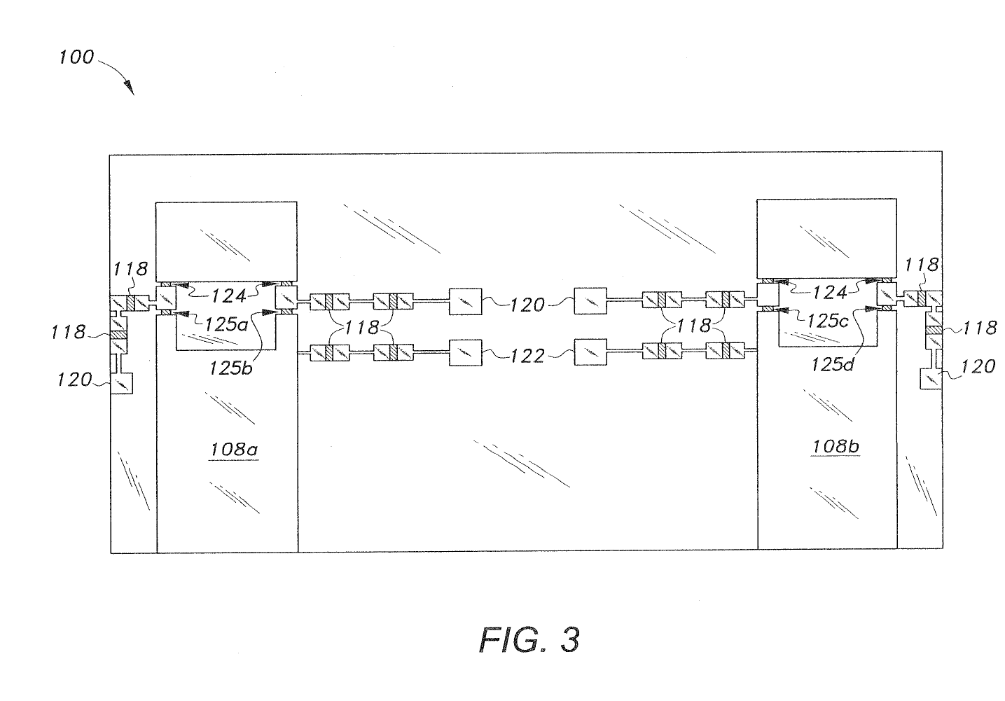

The upper or MIMO board 106 has two planar inverted-F antennas (PIFA) 108 formed thereon that are reconfigurable MIMO antennas. FIG. 3 shows a top view of the upper or MIMO board 106 containing the two MIMO reconfigurable antennas, designated as left antenna 108a and right antenna 108b for clarity in Table 1, below. The upper or MIMO board 106 has dimensions of about 65 mm×30 mm. Each PIFA antenna 108a, 108b has a radiating patch having a slot bridged by PIN diodes 125a, 125b, 125c, and 125d, respectively, and DC blocking capacitors 124 on opposite sides of the slot Each patch has dimensions of about 28 mm×16 mm. Each slot is about 12 mm×6.3 mm. Each side of the slot has a 1.9 mm pad connected to the upper portion of the patch by a blocking capacitor 124 and connected to the lower portion of the patch by a PIN diode 125a-125d. The PIN diodes have biasing circuitry 110 that includes a 1μH RF choke in series with a 2.1 kΩ resistor, the passive components being designated 118 in the drawing. A voltage V_{cc} is applied at pads 120, while a digital reference pad is shown at 122. The two MIMO reconfigurable antennas 108 are similar in structure.

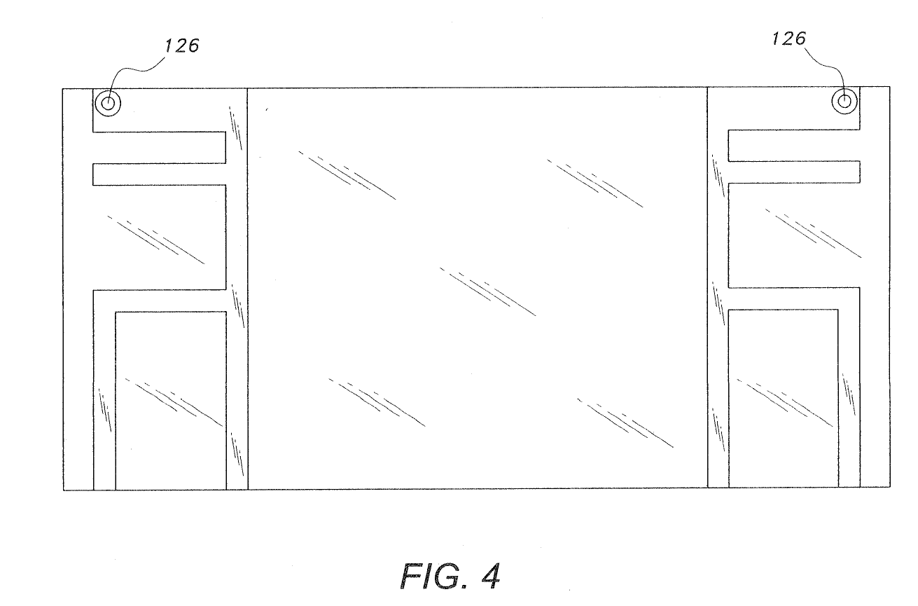

FIG. 4 shows the bottom face of the upper or MIMO board 106. The bottom face of the MIMO board 106 includes radiating lines and coax feed-lines, and two feed points 126 for the two elements. The dimensions of the different radiating parts of the bottom layer of the PIFA are 12 mm, 3.4 mm, 1.7 mm, 16 mm, 1.7 mm, 8.6 mm, and 30 mm.

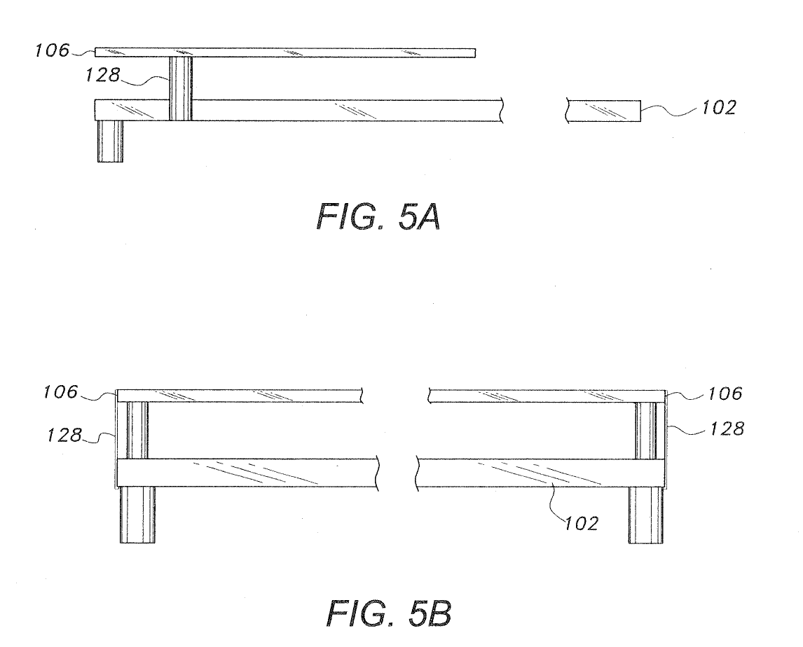

FIG. 5A is a side view of the elevated PIFA, while FIG. 5B shows a front view of the MIMO reconfigurable antenna 108. Both PIFAs are connected to the sensing element 104 of the UWB antenna through shorting walls 128 of width 1.7 mm extending between the edges of the upper or MIMO board 106 and the main board 102.

Returning now to FIGS. 1 and 2, it should be understood that the ground plane 112 is used as the reference ground plane for ultra-wideband antenna 104. The ground plane 112 is electrically connected to ultra-wideband antenna 104 using SMA connector 130. As is well known in the art, SubMiniature version A (SMA) connectors are semi-precision coaxial RF connectors. It should be understood that ground plane 112 may be in electrical communication with ultra-wideband antenna 104 by any suitable type of electrical connection, and that SMA 130 is shown for exemplary purposes only. In the example of an SMA coaxial connector, as illustrated in FIGS. 1 and 2, the inner conductor of the SMA coaxial connector 130 that carries the signal is connected to the ultra-wideband antenna 104, while the outer conductor of the SMA coaxial connector 130 is connected to the reference ground plane 112.

The ultra-wideband antenna 104 is used as a sensing antenna for the cognitive radio front-end, which is the first stage of cognition to identify the available bands via scanning of a wide range of frequencies. The second stage, which is the communication stage, is where the MIMO antennae 108 are utilized. In this stage, the ultra-wideband antenna 104 is utilized as the ground plane for the MIMO antenna 108.

Specifically, in the second stage of cognitive operation, the trapezoidal sensing element 107 of antenna 104 serves as a secondary ground plane for the MIMO antenna 108. The SMA connectors 116 electrically connect the MIMO antennae 108 to the secondary ground plane (i.e., trapezoidal sensing element 107 of antenna 104), as best shown in FIG. 1. It should be understood that secondary ground plane 107 may be in electrical communication with MIMO antennae 108 by any suitable type of electrical connection, and that SMA connectors 116 are shown for exemplary purposes only. In the example of SMA coaxial connectors, the center conductors (carrying the signals) of SMA coaxial connectors 116 are connected to the MIMO antennae 108, while the outer SMA conductor is connected to secondary ground plane 107 (i.e., the sensing portion of antenna 104).

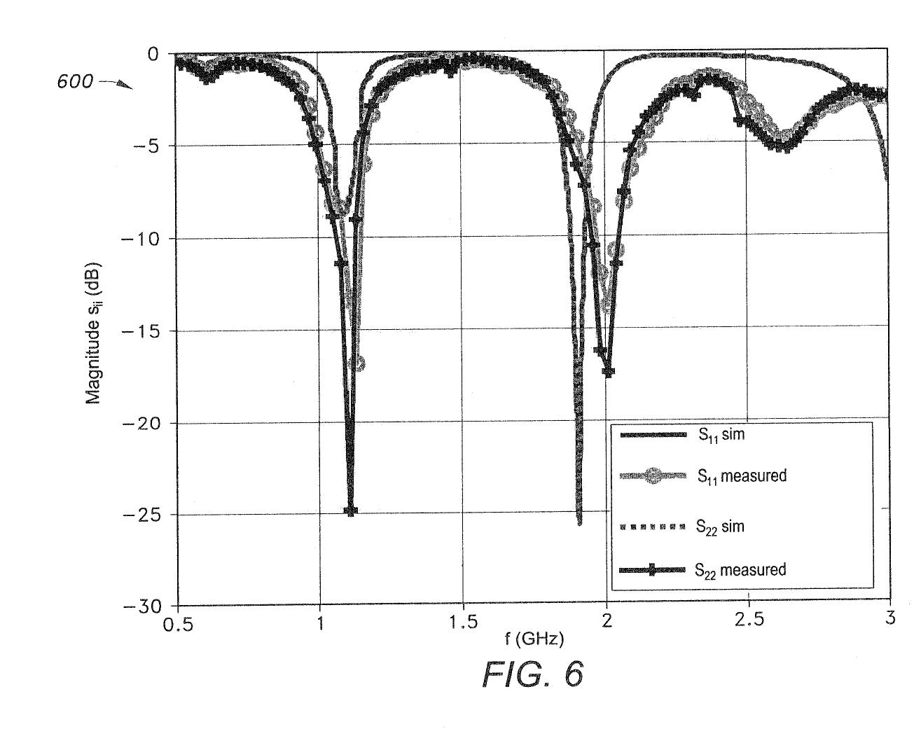

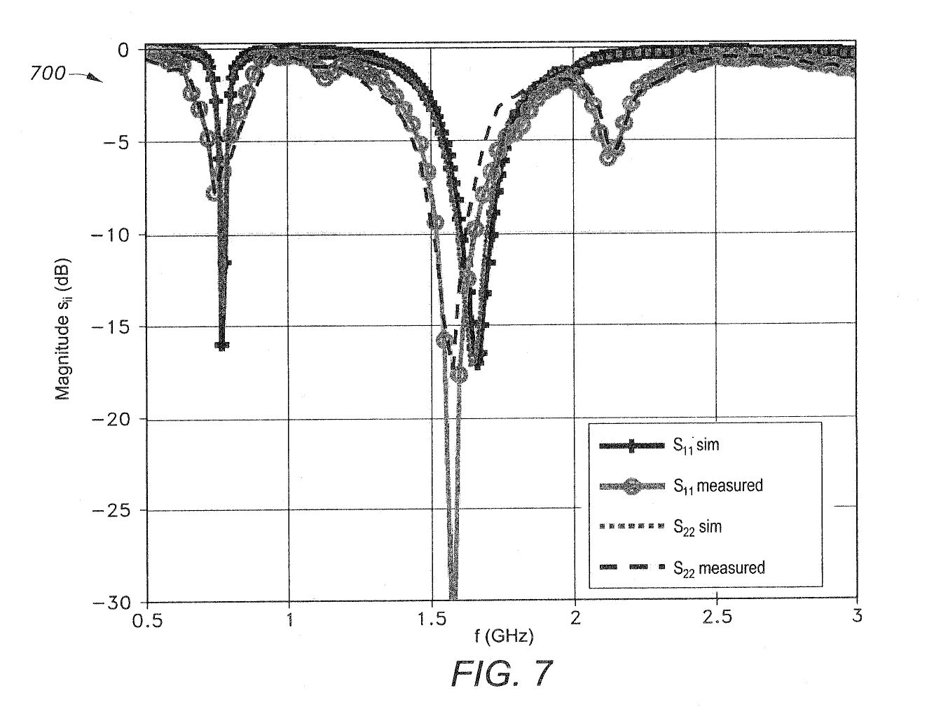

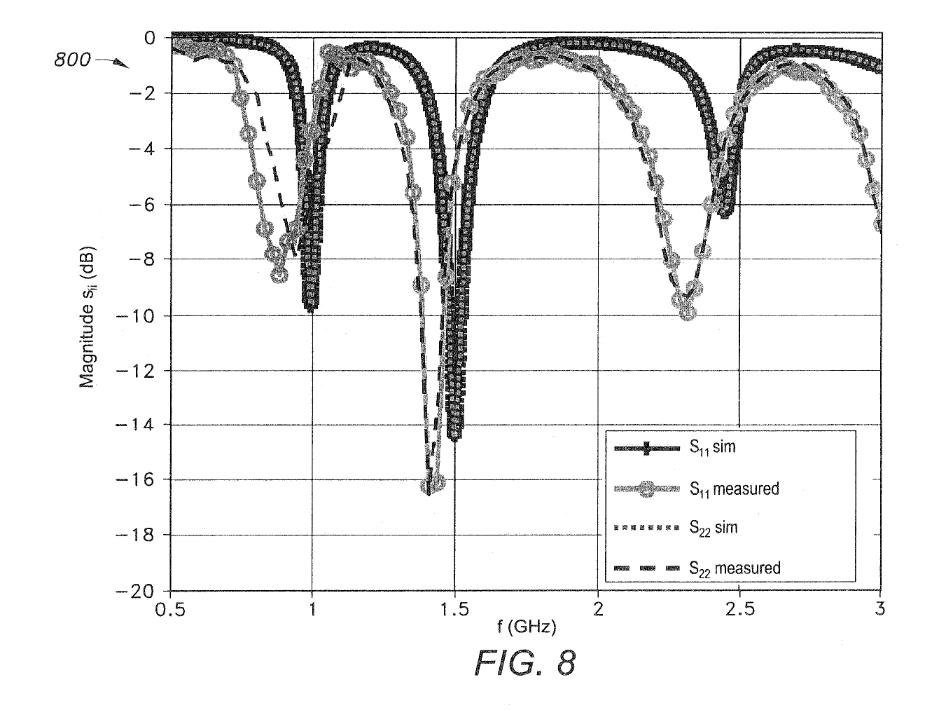

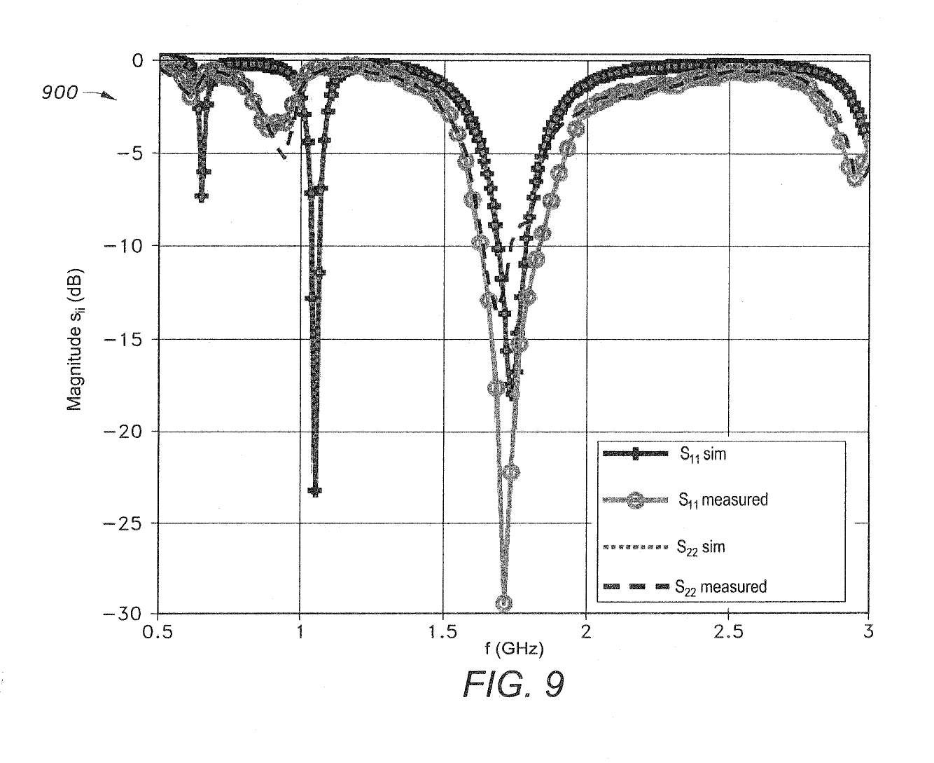

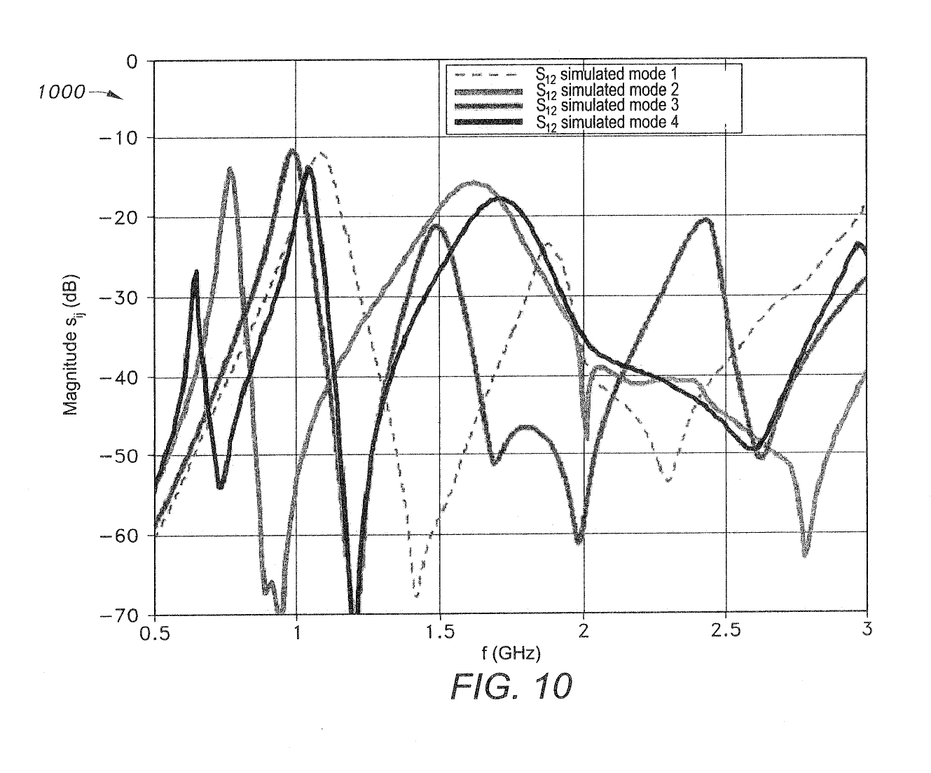

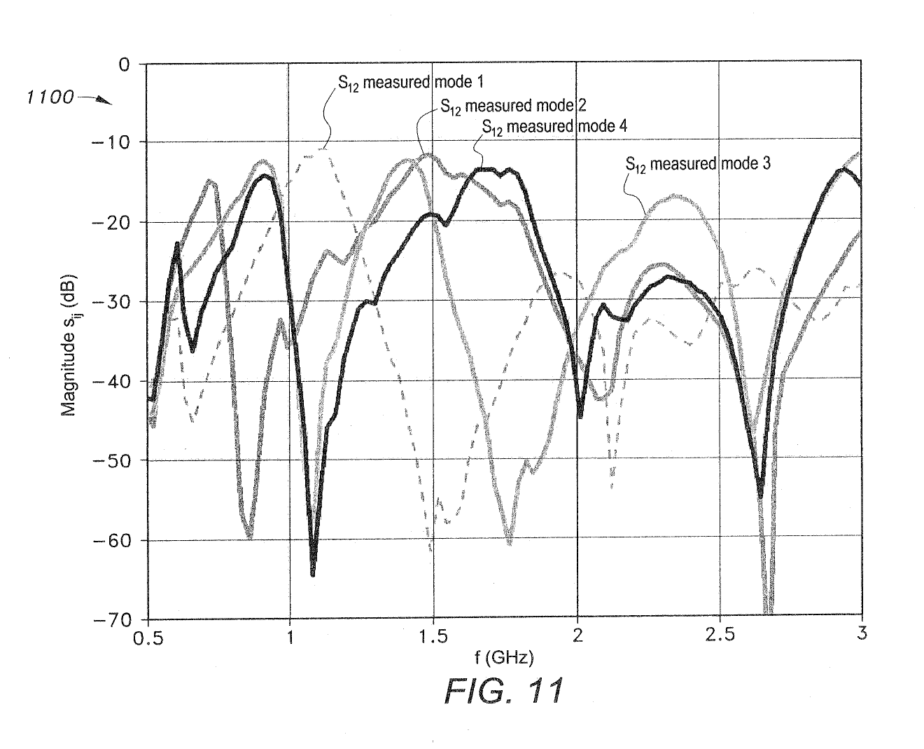

Referring to FIGS. 6-9, the compact reconfigurable MIMO antennas system 100 can operate in four different modes depending on the state of the four PIN diodes 125a-125b. The details of all modes are given in Table 1. The PIN diodes 125a-125d short the upper and lower portions of the PIFA patch antennas when they are turned ON (they are conducting), and leave the upper and lower portions open when they are OFF (they are not conducting) by adjusting the respective bias currents to the diodes 125a-125d, thereby altering the electrical length of the PIFA patch antennas and their corresponding resonant frequencies. In mode 1, the two resonating frequencies are 1093 MHz and 1900 MHz. The reflection coefficient curves 600 are shown in FIG. 6 for both simulated and fabricated models. In mode 2, both antennas were resonating at 770 MHz and 1640 MHz. The reflection coefficient curves 700 are shown in FIG. 7. Similarly, in mode 3, the resonating frequencies are 994 MHz and 1500 MHz, while in mode 4, the single resonating frequency achieved was 1740 MHz. The reflection coefficient curves 800 for mode 3 are shown in FIG. 8 and the reflection coefficient curves 900 of mode 4 are shown in FIG. 9. The simulated coupling curves 1000 are shown in FIG. 10 and the measured mutual coupling curves 1100 are shown in FIG. 11. Table 1 shows the switching state of the four PIN diodes 125a-125d in Modes 1 through 4. Table 2 shows the resulting resonant frequencies in the four modes.

TABLE 1
Diode Switching States in Mode 1 Through Mode 4

| | Diode 1-LA- | Diode 2-LA- | Diode 3-RA- | Diode 4-RA- |
|---|---|---|---|---|
| S. No. | LD 125a | RD 125b | LD 125c | RD 125d |
| Mode-1 | OFF | OFF | OFF | OFF |
| Mode-2 | ON | OFF | OFF | ON |
| Mode-3 | OFF | ON | ON | OFF |
| Mode-4 | ON | ON | ON | ON |

LA = Left Antenna (108a)
LD = Left Diode 125a or 125c
RA = Right Antenna (108b)
RD = Right Diode 125b or 125d

TABLE 2
Resonant Frequencies of PIFA Antennas

| S. No. | Band 1 | Band 2 |
|---|---|---|
| Mode-1 | 1093 | 1900 |
| Mode-2 | 770 | 1640 |
| Mode-3 | 994 | 1500 |
| Mode-4 | 1740 | — |

It will be seen that the antenna assembly 10 has a compact form factor, measuring 65×120 mm² and 5.8 mm high, rendering the assembly suitable for smart phones and LTE mobile handsets, as well as other compact wireless devices. The frequency range of the antenna assembly 10, including an ultra-wideband antenna for sensing the spectrum for available frequencies and reconfigurable multiband MIMO transmit and receive antennas to support communications on any available frequency, makes it suitable for a cognitive radio platform for 4G devices. The planar structure of the antennas and operating characteristics of the antennas and control circuitry are easily integrated with other microwave or digital ICs and other low profile microwave components so that the assembly 10 can be easily accommodated within wireless handheld devices in wireless bands between 700 MHz and 3 GHz.

It is to be understood that the present invention is not limited to the embodiments described above, but encompasses any and all embodiments within the scope of the following claims.

We claim:

1. A cognitive radio antenna assembly, comprising:
a main board having a top face and a bottom face, the bottom face having an ultra-wideband spectrum sensing antenna disposed thereon, the top face having a ground plane for the ultra-wideband antenna disposed thereon, the ground plane being in electrical communication with the ultra-wideband spectrum sensing antenna; and
an upper multiple-input-multiple-output (MIMO) board disposed above the main board, the upper MIMO board having a pair of reconfigurable multiband planar inverted-F antennas (PIFAs) disposed thereon, wherein the pair of reconfigurable multiband planar inverted-F antennas are in electrical communication with the ultra-wideband spectrum sensing antenna such that the ultra-wideband spectrum sensing antenna serves as a secondary ground plane for the pair of reconfigurable multiband planar inverted-F antennas.

2. The cognitive radio antenna assembly according to claim 1, wherein the ultra-wideband antenna is a monopole antenna.

3. The cognitive radio antenna assembly according to claim 1, wherein each said reconfigurable multiband planar inverted-F antenna comprises an elevated patch antenna having a slot defined therein, each said slot having slits formed on opposing sides thereof.

4. The cognitive radio antenna assembly according to claim 3, wherein each said elevated patch antenna of each said reconfigurable multiband planar inverted-F antenna further comprises an upper portion defined above the respective slot, a lower portion defined below the respective slot, and at least one PIN diode connected between the upper portion and the lower portion on opposite sides of the slot.

5. The cognitive radio antenna assembly according to claim 4, wherein the at least one PIN diode selectively shorts the upper and lower portions of the respective patch antenna when the at least one PIN diode is conducting in order to selectively change an electrical length and resonant frequency of the respective patch antenna.

6. The cognitive radio antenna assembly according to claim 1, wherein the ultra-wideband antenna and the reconfigurable multiband PIFAs are operable in frequency bands between 700 MHz and 3 GHz.

7. The cognitive radio antenna assembly according to claim 1, wherein the assembly is a substantially flat assembly measuring about 65×120 mm², being dimensioned and configured for use in smart phones and LTE mobile handsets.
